(19) United States
(12) Patent Application Publication
(10) Pub. No.: US 2025/0326298 A1
(43) Pub. Date: Oct. 23, 2025

(54) LOG-OFF AND LEFT BELONGINGS NOTIFICATION VIA VEHICLE DISPLAY

(71) Applicant: GM Global Technology Operations LLC, Detroit, MI (US)

(72) Inventors: Manoj Kumar Sharma, Troy, MI (US); Donald K. Grimm, Utica, MI (US); Joseph F. Szczerba, Grand Blanc, MI (US)

(21) Appl. No.: 18/637,990

(22) Filed: Apr. 17, 2024

(51) Int. Cl. B60K 35/81; B60K 35/25; B60K 35/28; B60K 35/65; B60W 50/14; B60W 50/16; H04W 4/44

(52) U.S. Cl. CPC B60K 35/81; B60K 35/25; B60K 35/28; B60K 35/65; B60W 50/16; H04W 4/44; B60K 2360/1438; B60K 2360/178; B60K 2360/195; B60K 2360/23; B60K 2360/334; B60K 2360/56; B60K 2360/589; B60W 2050/143; B60W 2050/146; B60W 2540/225; B60W 2540/227; B60W 2556/10; B60W 2556/45

(57) ABSTRACT

A system for automatically logging a user out of user specific content displayed on a vehicle display includes a vehicle display server in communication with a plurality of sensors adapted to track head and eye position and movement of users within the vehicle, detect locations of users and when users change locations within the vehicle, detect when a user enters and exits the vehicle, detect personal objects, haptic feedback devices, and a user display system, the vehicle display server adapted to detect when a user enters the vehicle, identify the user, detect a seating position within which the user sits, detect personal objects, associate the personal objects with the user, display user specific content on the user display system, detect when the user is no longer viewing the user specific content, and automatically terminate display of the user specific content and automatically log-out from the user specific content.

### INTRODUCTION

The present disclosure relates to a system for enabling automatic log-off from personal content displayed on a vehicle display and automatic notification when personal belongings are left within a vehicle via the vehicle display.

Current entertainment systems within vehicles generally comprise a screen or monitor that is mounted within the vehicle for viewing by the passengers. Some systems include smaller individual screens, wherein each passenger has a screen for their personal viewing. Current systems are primarily designed for individual users and do not take into consideration shared or multi-display vehicle compartments where content is determined based on identity of the user. Further, shared displays do not account for users that move to different seating positions within a vehicle or exit the vehicle, and require a user to manually terminate display of personal content when this occurs. Further, current systems do not associate personal belongings that are brought into the vehicle with a user within the vehicle such that if the user leaves without the personal belongings, the system automatically notifies the user.

While current systems achieve their intended purpose, there is a need for a new and improved system for enabling personalization and interaction via a vehicle display.

### SUMMARY

According to several aspects of the present disclosure, a system for automatically logging a user out of user specific content displayed on a vehicle display, includes a vehicle display server positioned within a vehicle and in communication with a plurality of sensors positioned within the vehicle and adapted to track head and eye position and movement of users seated within a plurality of seating positions within the vehicle, detect locations of users within the vehicle and when users change seating positions within the vehicle, detect when a user enters and exits the vehicle, detect personal objects that are brought into the vehicle by a user, haptic feedback devices positioned within the vehicle and adapted to provide haptic feedback to users seated within the vehicle, and a user display system positioned within the vehicle for viewing and interaction by users seated within the plurality of seating positions within the vehicle, the vehicle display server adapted to detect when a user enters the vehicle, identify, using the plurality of sensors positioned within the vehicle, computer vision algorithms and stored data, an identity of the user, detect, using the plurality of sensors positioned within the vehicle, a first one of the plurality of seating positions within which the user sits, detect, using the plurality of sensors positioned within the vehicle, personal objects brought into the vehicle by the user, associate, using artificial intelligence and machine learning algorithms, the detected personal objects, with the user, display user specific content on the user display system for viewing by the user, detect when the user is no longer viewing the user specific content on the user display system, and automatically terminate display of the user specific content and automatically log-out from the user specific content when the user is no longer viewing the user specific content on the user display system.

According to another aspect, the vehicle display server is further adapted to detect when the user has looked away from the user display system and is still seated within the first one of the plurality of seating positions within the vehicle, pause display of the user specific content for the user on the user display system, and, when a pre-determined amount of time has passed, terminate display of the user specific content and automatically log-out from the user specific content.

According to another aspect, the vehicle display server is further adapted to detect when the user has moved away from the one of the plurality of seating positions within the vehicle, pause display of the user specific content for the user on the user display system at the first one of the plurality of seating positions; and at least one of, when a pre-determined amount of time has passed, automatically terminate display of the user specific content and automatically log-out from the user specific content that is being displayed on the user display system at the first one of the plurality of seating positions, detect, with the plurality of sensors, that the user has moved to a second one of the plurality of seating positions, and automatically terminate display of the user specific content and automatically log-out from the user specific content that is being displayed by the user display system at the first one of the plurality of seating positions, detect, with the plurality of sensors, that another passenger has moved into the first one of the plurality of seating positions, and automatically terminate display of the user specific content and automatically log-out from the user specific content that is being displayed by the user display system at the first one of the plurality of seating positions, and, detect, with the plurality of sensors, that the user has exited the vehicle, and automatically terminate display of the user specific content and automatically log-out from the user specific content that is being displayed by the user display system at the first one of the plurality of seating positions.

According to another aspect, the vehicle display server is further adapted to detect, with the plurality of sensors, when the user has moved away from the first one of the plurality of seating positions and has left at least one personal object associated with the user at the first one of the plurality of seating positions, and, provide an alert for the user to notify the user that at least one personal object associated with the user has been left within the first one of the plurality of seating positions.

According to another aspect, the vehicle display server is further adapted to detect, with the plurality of sensors, when the user has moved away from the first one of the plurality of seating positions and has taken at least one personal object associated with a different passenger, and, provide an alert for the user to notify the user that the user has taken at least one personal object associated with a different passenger.

According to another aspect, the vehicle display server is further adapted to detect, with the plurality of sensors, when a different passenger within the vehicle has moved from one of the plurality of seating positions within the vehicle and has taken at least one personal object associated with the user, and, provide an alert for the user to notify the user that another passenger has taken at least one personal object associated with the user.

According to another aspect, the alert provided by the vehicle display server includes at least one of an audible chime or bell, verbal alerts broadcast generally within the vehicle, directional verbal alerts, broadcast specifically to the user, user specific graphics and textual messages displayed on the user display system, user specific haptic alerts provided by the plurality of haptic devices within the vehicle, and disabling doors of the vehicle.

According to another aspect, the system further includes a personal device of the user that is registered with and linked to the system, wherein alerts provided by the vehicle display server include alerts sent to the user's personal device.

According to another aspect, the user display system comprises one of, a plurality of individual display screens adapted to display information and receive input from a user, one individual display screen associated with each of the plurality of seating positions within the vehicle, or, a single display system comprising at least one display for projecting an image, a plurality of reflectors, each reflector associated with a one of the plurality of seating positions within the vehicle and adapted to reflect a projected image to the associated one of the plurality of seating positions, such that a user seated at the associated one of the plurality of seating positions within the vehicle perceives the image floating at a central location within the vehicle, and, a transparent cylindrical touch screen display positioned between the plurality of seating positions within the vehicle and the plurality of reflectors and adapted to display user specific content for users at each of the plurality of seating positions within the vehicle and receive input from each of the users at each of the plurality of seating positions within the vehicle.

According to another aspect, for the user display system comprising a single display system, the plurality of reflectors comprises a plurality of transparent beam splitters, one transparent beam splitter individually associated with each one of the plurality of seating positions within the vehicle, each beam splitter adapted to receive an image from the at least one display and to reflect the image to the associated one of the plurality of seating positions, wherein, a user seated at the associated one of the plurality of seating positions within the vehicle perceives the image floating at a central location within the vehicle.

According to another aspect, for the user display system comprising a single display system, the user display system further includes an image chamber including at least one display adapted to project an image, a reflector individually associated with each one of the plurality of seating positions within the vehicle and adapted to reflect the image to the associated one of the plurality of seating positions within the vehicle, such that a user seated at the associated one of the plurality of seating positions within the vehicle perceives the image floating at a central location within the vehicle, transparent portions adapted to allow the image reflected by the reflector to pass from the image chamber outward toward a user seated at the associated one of the plurality of seating positions, and solid portions adapted to prevent light from entering the image chamber behind the reflector, and, the transparent cylindrical touch screen display positioned between the reflectors of the image chamber and the plurality of seating positions within the vehicle, and adapted to display information to users seated at the plurality of seating locations within the vehicle within an image plane positioned in front of the perceived image floating at the central location within the vehicle.

According to another aspect, the system further includes a cloud-based host server in communication, via a wireless communication network, with the vehicle display server within the vehicle, the cloud-based host server adapted to receive and store historical data related to past instances of identification of the user by the vehicle display server within the vehicle and by other vehicles linked to the system and association of personal objects with the user, wherein, when identifying the user and associating personal objects with the user, the vehicle display server is adapted to utilize machine learning and artificial intelligence algorithms and probabilistic calculations based on the stored historical data.

According to several aspects of the present disclosure, a method of automatically logging a user out of user specific content displayed on a vehicle display having a vehicle display server positioned within a vehicle and in communication with a plurality of sensors positioned within the vehicle and adapted to track head and eye position and movement of users seated within a plurality of seating positions within the vehicle, detect locations of users within the vehicle and when users change seating positions within the vehicle, detect when a user enters and exits the vehicle, detect personal objects that are brought into the vehicle by a user, haptic feedback devices positioned within the vehicle and adapted to provide haptic feedback to users seated within the vehicle, and, a user display system positioned within the vehicle for viewing and interaction by users seated within the plurality of seating positions within the vehicle, the method including, with the vehicle display server, detecting when a user enters the vehicle, identifying, using the plurality of sensors positioned within the vehicle, computer vision algorithms and stored data, an identity of the user, detecting, using the plurality of sensors positioned within the vehicle, a first one of the plurality of seating positions within which the user sits, detecting, using the plurality of sensors positioned within the vehicle, personal objects brought into the vehicle by the user, associating, using artificial intelligence and machine learning algorithms, the detected personal objects, with the user, displaying user specific content on the user display system for viewing by the user, detecting when the user is no longer viewing the user specific content on the user display system, and automatically terminating display of the user specific content and automatically logging-out from the user specific content when the user is no longer viewing the user specific content on the user display system.

According to another aspect, the method further includes, with the vehicle display server, detecting when the user has looked away from the user display system and is still seated within the first one of the plurality of seating positions within the vehicle, pausing display of the user specific content for the user on the user display system, and, when a pre-determined amount of time has passed, terminating display of the user specific content and automatically logging-out from the user specific content.

According to another aspect, the method further includes, with the vehicle display server, detecting when the user has moved away from the one of the plurality of seating positions within the vehicle, pausing display of the user specific content for the user on the user display system at the first one of the plurality of seating positions; and, at least one of, when a pre-determined amount of time has passed, automatically terminating display of the user specific content and automatically logging-out from the user specific content that is being displayed on the user display system at the first one of the plurality of seating positions, detecting, with the plurality of sensors, that the user has moved to a second one of the plurality of seating positions, and automatically terminating display of the user specific content and automatically logging-out from the user specific content that is being displayed by the user display system at the first one of the plurality of seating positions, detecting, with the plurality of sensors, that another passenger has moved into the first one of the plurality of seating positions, and automatically terminating display of the user specific content and automatically logging-out from the user specific content that is being displayed by the user display system at the first one of the plurality of seating positions, and, detecting, with the plurality of sensors, that the user has exited the vehicle, and automatically terminating display of the user specific content and automatically logging-out from the user specific content that is being displayed by the user display system at the first one of the plurality of seating positions.

According to another aspect, the method further includes, with the vehicle display server, detecting, with the plurality of sensors, when the user has moved away from the first one of the plurality of seating positions and has left at least one personal object associated with the user at the first one of the plurality of seating positions, and providing an alert for the user to notify the user that at least one personal object associated with the user has been left within the first one of the plurality of seating positions, detecting, with the plurality of sensors, when the user has moved away from the first one of the plurality of seating positions and has taken at least one personal object associated with a different passenger, and providing an alert for the user to notify the user that the user has taken at least one personal object associated with a different passenger, and, detecting, with the plurality of sensors, when a different passenger within the vehicle has moved from one of the plurality of seating positions within the vehicle and has taken at least one personal object associated with the user, and providing an alert for the user to notify the user that another passenger has taken at least one personal object associated with the user.

According to another aspect, the providing an alert by the vehicle display server includes at least one of providing an audible chime or bell, providing verbal alerts broadcast generally within the vehicle, providing directional verbal alerts, broadcast specifically to the user, providing user specific graphics and textual messages displayed on the user display system, providing user specific haptic alerts with the plurality of haptic devices within the vehicle, and disabling doors of the vehicle.

According to another aspect, wherein the system further includes a personal device of the user that is registered with and linked to the system, wherein, the providing an alert by the vehicle display server further includes sending an alert to the user's personal device.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic view of a system in accordance with an exemplary embodiment of the present disclosure;

FIG. 2 is a schematic view of the system shown in FIG. 1, wherein the vehicle display system include a plurality of individual touch screen displays;

FIG. 3 is a schematic top view of a vehicle having a system in accordance with the present disclosure;

FIG. 4 is a schematic side view of a vehicle display system having display, a plurality of beam splitters and a cylindrical touch screen display;

FIG. 5 is a schematic side view of a vehicle display system having an image chamber including a display, a plurality of reflectors and a cylindrical touch screen display;

FIG. 6 is a schematic top view of the image chamber shown in FIG. 5;

FIG. 7 is a schematic side view of the image chamber shown in FIG. 5 illustrating how the reflectors and displays of the image chamber move up and down and rotate;

FIG. 8 is a schematic top view of the image chamber shown in FIG. 6, wherein a user at the second seating position has moves and in response, the second reflector and second display have rotated and angular distance to maintain alignment with the user at the second seating position;

FIG. 9 is a schematic view illustrating a user viewing an image and annotation information through an associated beam splitter and transparent touch screen display;

FIG. 10 is a perspective view of a user seated within a seating position with the vehicle and having personal objects with the user;

FIG. 11 is a perspective view of another passenger taking a personal object associated with the user;

FIG. 12 is a perspective view of a user receiving an alert on a personal device; and

FIG. 13 is a flow chart illustrating a method according to an exemplary embodiment of the present disclosure.

The figures are not necessarily to scale, and some features may be exaggerated or minimized, such as to show details of particular components. In some instances, well-known components, systems, materials or methods have not been described in detail in order to avoid obscuring the present disclosure. Therefore, specific structural and functional details disclosed herein are not to be interpreted as limiting, but merely as a basis for the claims and as a representative basis for teaching one skilled in the art to variously employ the present disclosure.

### DETAILED DESCRIPTION

The following description is merely exemplary in nature and is not intended to limit the present disclosure, application, or uses. Furthermore, there is no intention to be bound by any expressed or implied theory presented in the preceding technical field, background, brief summary or the following detailed description. It should be understood that throughout the drawings, corresponding reference numerals indicate like or corresponding parts and features. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality. Although the figures shown herein depict an example with certain arrangements of elements, additional intervening elements, devices, features, or components may be present in actual embodiments. It should also be understood that the figures are merely illustrative and may not be drawn to scale.

As used herein, the term “vehicle” is not limited to automobiles. While the present technology is described primarily herein in connection with automobiles, the technology is not limited to automobiles. The concepts can be used in a wide variety of applications, such as in connection with aircraft, marine craft, other vehicles, and consumer electronic components.

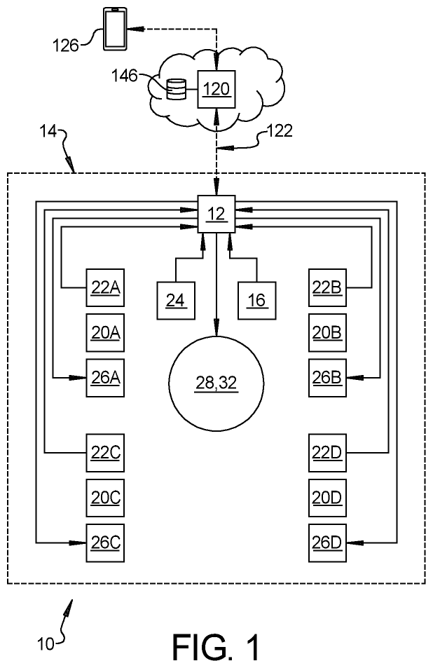

Referring to FIG. 1, a system 10 for automatically logging a user 18 out of user specific content displayed on a vehicle display system 28 includes a vehicle display server 12 positioned within a vehicle 14 and in communication with a plurality of sensors 16 positioned within the vehicle 14. The plurality of sensors 16 sense observable conditions of the exterior environment and the interior environment of the vehicle 14. The plurality of sensors 16 can include, but are not limited to, radars, lidars, global positioning systems, optical cameras, thermal cameras, ultrasonic sensors, pressure sensors and/or other sensors. The cameras can include two or more digital cameras spaced at a selected distance from each other, in which the two or more digital cameras are used to obtain stereoscopic images of the surrounding environment in order to obtain a three-dimensional image or map. The plurality of sensors 16 is used to determine information about an environment surrounding the vehicle 14. In an exemplary embodiment, the plurality of sensors 16 includes at least one of a motor speed sensor, a motor torque sensor, an electric drive motor voltage and/or current sensor, an accelerator pedal position sensor, a coolant temperature sensor, a cooling fan speed sensor, and a transmission oil temperature sensor. In another exemplary embodiment, the plurality of sensors 16 further includes sensors to determine information about the environment surrounding the vehicle 14, for example, an ambient air temperature sensor, a barometric pressure sensor, and/or a photo and/or video camera which is positioned to view the environment in front of the vehicle 14. In another exemplary embodiment, at least one of the plurality of sensors 16 is capable of measuring distances in the environment surrounding the vehicle 14.

In a non-limiting example, wherein the plurality of sensors 16 includes a camera, the plurality of sensors 16 measures distances using an image processing algorithm configured to process images from the camera and determine distances between objects. In another non-limiting example, the plurality of sensors 16 includes a stereoscopic camera having distance measurement capabilities. In one example, at least one of the plurality of sensors 16 is affixed inside of the vehicle 14, for example, in a headliner of the vehicle 14, having a view through the windshield of the vehicle 14. In another example, at least one of the plurality of sensors 16 is a camera affixed outside of the vehicle 14, for example, on a roof of the vehicle 14, having a view of the environment surrounding the vehicle 14 and adapted to collect information (images) related to the environment outside the vehicle 14.

In an exemplary embodiment, the plurality of sensors 16 includes cameras and sensors adapted to capture images of and detect/monitor movement of users 18 seated within the vehicle 14. Such sensors 16 may include pressure sensors within a plurality of seating positions 20A, 20B, 20C, 20D within the vehicle 14 to determine if a user 18 is seated within a particular seating position 20A, 20B, 20C, 20D within the vehicle 14. Such sensors 16 may also include cameras adapted to capture images of users 18 within the vehicle 14 and, using computer vision algorithms and software, use such captured images to determine movement of users 18 within the vehicle 14 and identity of users 18 within the vehicle 14, wherein such sensors 16 can detect where a user is seated within the vehicle and detect when the user 18 changes seating positions within the vehicle 14 as well as detecting when a user enters or exits the vehicle 14 and when a user 18 is intending to exit the vehicle 14, based on movements made by the user 18. Such sensors 16 may be incorporated into monitoring systems adapted to monitor the eyes and head orientation/movement of users 18 within the vehicle 14 to determine gaze direction of a user 18 or when a user 18 is not fully alert or distracted. It should be understood that various additional types of sensing devices, such as, for example, LiDAR sensors, ultrasonic ranging sensors, radar sensors, and/or time-of-flight sensors are within the scope of the present disclosure.

The plurality of sensors 16 are further adapted to detect personal objects that are brought into the vehicle 14 by a user 18. Referring to FIG. 10, wherein a user 18 is seated within the vehicle 14 at the first seating position 20A, such as when the system 10 uses the plurality of sensors 16, and specifically, the first occupant monitoring camera 22A, to identify a user 18, as described above and as indicated by line 150, the vehicle display server 12 uses other cameras 152 and sensors within the plurality of sensors 16, to capture images of personal objects 154A, 154B, 154C, 154D carried into the vehicle 14 by the users 18, as indicated by lines 156A, 156B, 156C, 156D and uses computer vision algorithms and software to identify such personal objects 154A, 154B, 154C, 154D. As shown in FIG. 10, the user 18 is wearing a pair of earmuffs 154A and carried a purse 154B, a duffel bag 154C and a suitcase 154D into the vehicle 14. The vehicle display server 12 detects the personal objects 154A, 154B, 154C, 154D with a camera 152 included within the plurality of sensors 16 and uses computer vision techniques to identify the personal objects 154A, 154B, 154C, 154D.

Further, the vehicle display server 12 uses computer vision algorithms and artificial intelligence software to associate the personal objects 154A, 154B, 154C, 154D with the user 18. The vehicle display server 12 will associate the personal objects 154A, 154B, 154C, 154D based on data, such as the timing of the arrival of the user 18 and the personal objects 154A, 154B, 154C, 154D and the proximity of the personal objects 134A, 134B, 134C, 134D to the user 18 when first detected. In an exemplary embodiment, the vehicle display server 12 will associate the personal objects 154A, 154B, 154C, 154D with the user 18 based on probabilistic calculations using a machine learning algorithm and stored data within the database 146 from previous instances of identifying/associating the personal objects 154A, 154B, 154C, 154D and the user 18.

In an exemplary embodiment, the system further includes a cloud-based host server 120 in communication, via a wireless communication network 122, with the vehicle display server 12 within the vehicle 14. The cloud-based host server 120 is adapted to receive and store historical data related to past instances of identification of the user 18 by the vehicle display server 12 within the vehicle 14 and by other vehicles linked to the system 10 and association of personal objects 154A, 154B, 154C, 154D with the user 18, within a database 146 wherein, when identifying the user 18 and associating personal objects 154A, 154B, 154C, 154D with the user 18, the vehicle display server 12 is adapted to utilize machine learning and artificial intelligence algorithms and probabilistic calculations based on the stored historical data.

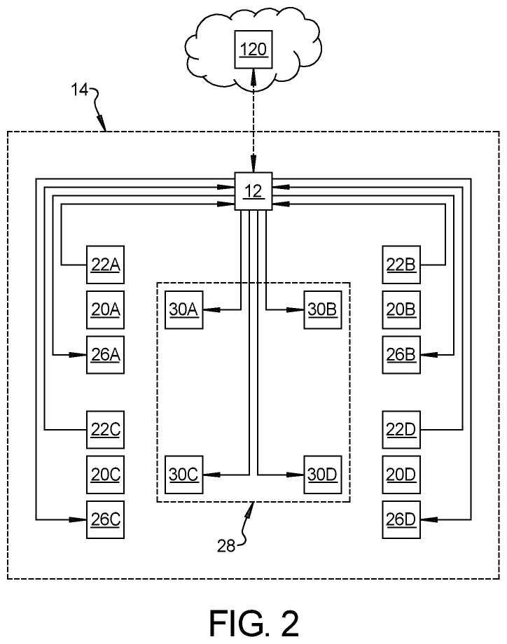

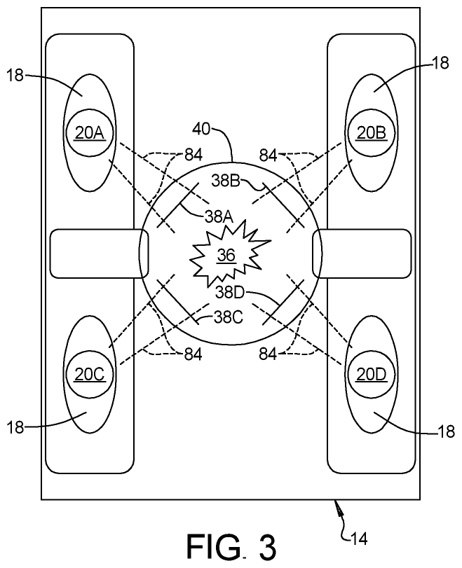

In an exemplary embodiment, the vehicle 14 includes a plurality of seating positions 20A, 20B, 20C, 20D adapted to accommodate a user 18 seated therein. Referring to FIG. 1, FIG. 2, and FIG. 3, as shown, the vehicle 14 includes a first seating position 20A, a second seating position 20B, a third seating position 20C and a fourth seating position 20D. It should be understood that the vehicle 14 could include more or less than four seating positions. The plurality of sensors 16 includes, at least, a first occupant monitoring camera 22A for monitoring head and eye position and movement of a user 18 seated within the first seating position 20A, a second occupant monitoring camera 22B for monitoring head and eye position and movement of a user 18 seated within the second seating position 20B, a third occupant monitoring camera 22C for monitoring head and eye position and movement of a user 18 seated within the third seating position 20C, and a fourth occupant monitoring camera 22D for monitoring head and eye position and movement of a user 18 seated within the fourth seating position 20D within the vehicle 14.

The first, second, third and fourth occupant monitoring cameras 22A, 22B, 22C, 22D are adapted to, along with other sensors within the vehicle 14, continuously track head and eye position and movement of users 18 seated within the plurality of seating positions 20A, 20B, 20C, 20D within the vehicle 14 and detect the locations of users 18 within the vehicle 14 and when users 18 change seating positions within the vehicle 14. The first, second, third and fourth occupant monitoring cameras 22A, 22B, 22C, 22D, and/or other of the plurality of sensors 16 within the vehicle 14, are adapted to detect when a user 18 enters and exits the vehicle 14, detect and interpret facial and gesture inputs from users 18 within the vehicle 14, capture images of users 18 within the vehicle 14, and receive audio inputs from users 18 within the vehicle 14, wherein the plurality of sensors 16 includes at least one microphone 24 within the vehicle 14. The plurality of sensors 16 is further adapted to detect and identify personal objects that are brought into the vehicle by a user 18.

Images, audio and data collected by the plurality of sensors 16, 22A, 22B, 22C, 22D, 24 is communicated back to the vehicle display server 12. The vehicle display server 12 is a non-generalized, electronic control device having a preprogrammed digital computer or processor, memory or non-transitory computer readable medium used to store data such as control logic, software applications, instructions, computer code, data, lookup tables, etc., and a transceiver [or input/output ports]. Computer readable medium includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device. Computer code includes any type of program code, including source code, object code, and executable code.

The vehicle display server 12 is further in communication with haptic feedback devices 26A, 26B, 26C, 26D positioned within the vehicle 14 and adapted to provide haptic feedback to users 18 seated within the vehicle 14. Haptic feedback devices 26A, 26B, 26C, 26D may be actuators mounted within surfaces of the interior of the vehicle 14 or vehicle seats and adapted to provide feedback that can be felt by a user. As shown, the vehicle includes first haptic feedback devices 26A that are adapted to provide haptic feedback to a user 18 seated within the first seating position 20A, second haptic feedback devices 26B that are adapted to provide haptic feedback to a user 18 seated within the second seating position 20B, third haptic feedback devices 26C that are adapted to provide haptic feedback to a user 18 seated within the third seating position 20C, and fourth haptic feedback devices 26D that are adapted to provide haptic feedback to a user 18 seated within the fourth seating position 20D within the vehicle 14.

The vehicle display server 12 is further in communication with a user display system 28 positioned within the vehicle 14 for viewing and interaction by users 18 seated within the plurality of seating positions 20A, 20B, 20C, 20D within the vehicle 14. The user display system 28 provides video and audio output to the users 18 within the vehicle 14, allowing users 18 to view media accounts, watch movies, view augmented images of the environment outside the vehicle 14, or play games with other users 18 within the vehicle 14 or within other remote vehicles.

In an exemplary embodiment, the user display system 28 comprises one of 1) a plurality of individual display screens 30A, 30B, 30C, 30D adapted to display information and receive input from a user 18, one individual display screen 30A, 30B, 30C, 30D associated with each of the plurality of seating positions 20A, 20B, 20C, 20D within the vehicle 14, or 2) the user display system 28 comprises a single display system 32 including at least one display 34 for projecting an image 36, a plurality of reflectors 38A, 38B, 38C, 38D, each of the plurality of reflectors 38A, 38B, 38C, 38D associated with a one of the plurality of seating positions 20A, 20B, 20C, 20D within the vehicle 14 and adapted to reflect a projected image 36 to the associated one of the plurality of seating positions 20A, 20B, 20C, 20D, such that a user 18 seated at the associated one of the plurality of seating positions 20A, 20B, 20C, 20D within the vehicle 14 perceives the image 36 floating at a central location within the vehicle 14, and a transparent cylindrical touch screen display 40 positioned between the plurality of seating positions 20A, 20B, 20C, 20D within the vehicle 14 and the plurality of reflectors 38A, 38B, 38C, 38D and adapted to display user specific content for users 18 at each of the plurality of seating positions 20A, 20B, 20C, 20D within the vehicle 14 and receive input from each of the users 18 at each of the plurality of seating positions 20A, 20B, 20C, 20D within the vehicle 14.

Referring to FIG. 2, in an exemplary embodiment the user display system 28 includes a plurality of individual display screens 30A, 30B, 30C, 30D adapted to display information and receive input from a user 18. As shown in FIG. 2, the vehicle 14 includes the first, second, third and fourth seating positions 20A, 20B, 20C, 20D, and a first individual display screen 30A is associated with the first seating position 20A for viewing by a user 18 seated within the first seating position 20A, a second individual display screen 30B is associated with the second seating position 20B for viewing by a user 18 seated within the second seating position 20B, a third individual display screen 30C is associated with the third seating position 20C for viewing by a user 18 seated within the third seating position 20C, and a fourth individual display screen 30D is associated with the fourth seating position 20D for viewing by a user 18 seated within the fourth seating position 20D. As users 18 move around within the vehicle 14 and sit at the first, second, third and fourth seating positions 20A, 20B, 20C, 20D, and possibly at positions between the first, second, third and fourth seating positions 20A, 20B, 20C, 20D, the system 10 will use the plurality of sensors 16, including the first, second, third and fourth occupant monitoring cameras 22A, 22B, 22C, 22D to determine which of the plurality of individual display screens 30A, 30B, 30C, 30D is best positioned to provide viewing for a particular user 18 based on the exact position of the user 18 relative to the plurality of individual display screens 30A, 30B, 30C, 30D and the user's 18 eye position and gaze angle relative to the plurality of individual display screens 30A, 30B, 30C, 30D.

The first, second, third and fourth individual display screens 30A, 30B, 300, 30D are adapted to display visual content for users 18 and to allow users 18 to provide input to the system 10. In an exemplary embodiment, the first, second, third and fourth individual display screens 30A, 30B, 30C, 30D include a touch screen features that allow a user 18 to interact with the system 10 and with the displayed content by manually touching the first, second, third and fourth individual display screens 30A, 30B, 300, 30D. It should be understood that the first, second, third and fourth individual display screens 30A, 30B, 300, 30D of the exemplary embodiment shown in FIG. 2, may be any known type of display screen adapted for use within a vehicle 14, with or without touch screen features, without departing from the scope of the present disclosure.

Referring again to FIG. 1 and to FIG. 3, in another exemplary embodiment, the user display system 28 comprises a single display system 32 including at least one display 34 for projecting an image 36, a plurality of reflectors 38A, 38B, 38C, 38D, each of the plurality of reflectors 38A, 38B, 38C, 38D associated with a one of the plurality of seating positions 20A, 20B, 20C, 20D within the vehicle 14 and adapted to reflect a projected image 36 to the associated one of the plurality of seating positions 20A, 20B, 20C, 20D, such that a user 18 seated at the associated one of the plurality of seating positions 20A, 20B, 20C, 20D within the vehicle 14 perceives the image 36 floating at a central location within the vehicle 14, and a transparent cylindrical touch screen display 40 positioned between the plurality of seating positions 20A, 20B, 20C, 20D within the vehicle 14 and the plurality of reflectors 38A, 38B, 38C, 38D and adapted to display user specific content for users 18 at each of the plurality of seating positions 20A, 20B, 20C, 20D within the vehicle 14 and receive input from each of the users 18 at each of the plurality of seating positions 20A, 20B, 20C, 20D within the vehicle 14.

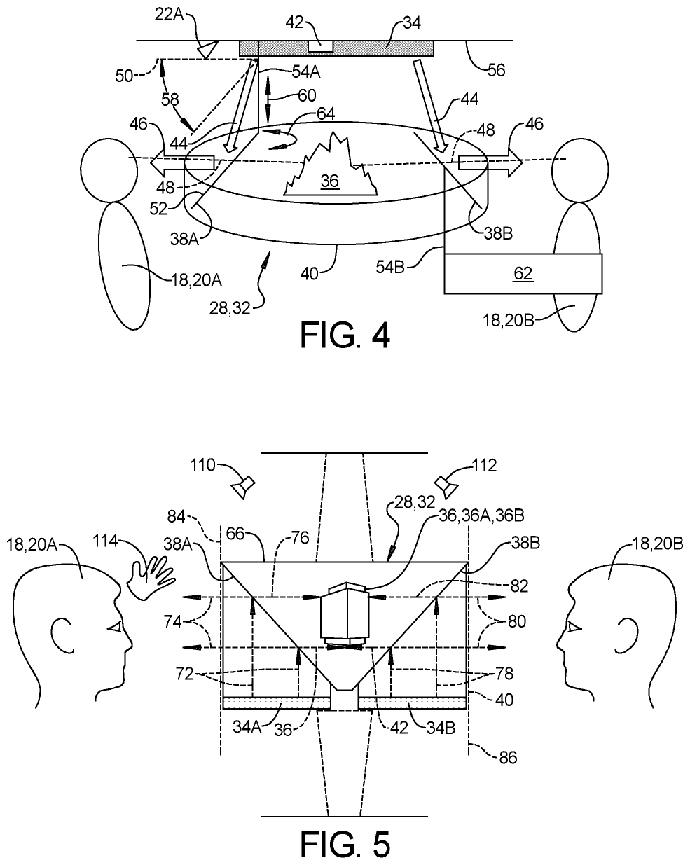

Referring to FIG. 3 and FIG. 4, in an exemplary embodiment, the user display system 28, 32 includes at least one display 34 that is adapted to project a plurality of three-dimensional images and a plurality of reflectors 38A, 38B, 38C, 38D, wherein the reflectors 38A, 38B, 38C, 38D are transparent beam splitters. One reflector/beam splitter 38A, 38B, 38C, 38D individually associated with each one of the plurality of seating positions 20A, 20B, 20C, 20D within the vehicle 14. For detailed description herein, FIG. 4 is an side schematic side view illustration of only the first seating position 20A and the second seating position 20B of the vehicle 14 shown in FIG. 1 and FIG. 3. The plurality of three-dimensional images may be generated via holographic method, pre-computed and encoded into a hologram generator 42 within the at least one display 34.

The transparent cylindrical touch screen display 40 is positioned between the first, second, third and fourth seating positions 20A, 20B, 20C, 20D and the perceived image 36 floating at the central location within the vehicle 14. The transparent cylindrical touch screen display 40 is adapted to allow users 18 seated within the first, second, third and fourth seating positions 20A, 20B, 20C, 20D to receive annotated information and to provide input to the system 10. As shown, the transparent cylindrical touch screen display 40 encircles the floating image 36, and is thereby positioned between the eyes of users 18 seated within the first, second, third and fourth seating positions 20A, 20B, 20C, 20D and the perceived image 36 floating at the central location within the vehicle 14. In an exemplary embodiment, the transparent cylindrical touch screen display 40 is an organic light-emitting diode (OLED). It should be understood, that the transparent cylindrical touch screen display 40 may be other types of transparent touch screen displays known in the art.

The transparent cylindrical touch screen display 40 is adapted to present visible displayed information only to a user 18 that is seated within one of the first, second, third and fourth seating positions 20A, 20B, 20C, 20D, wherein, the content displayed, for example, for a user seated within the first seating position 20A is only visible by the user 18 seated within the first seating position 20A and is different from content displayed for other seating positions within the vehicle 14.

Referring again to FIG. 4, the at least one display 34 is adapted to project the plurality of three-dimensional images to one of the plurality of reflectors/beam splitters 38A, 38B, 38C, 38D, as indicated by arrows 44. Each of the plurality of reflector/beam splitters 38A, 38B, 38C, 38D is adapted to receive one of the plurality of three-dimensional images from the display 34 and to reflect the one of the plurality of three-dimensional images from the display 34 to a user 18 seated at one of the plurality of seating positions 20A, 20B, 200, 20D, as indicated by arrows 46. Users at each of the plurality of seating positions 20A, 20B, 20C, 20D perceives the floating image 36 at a location centrally located within the vehicle 14, as indicated by lines 48.

Each of the plurality of reflectors/beam splitters 38A, 38B, 38C, 38D and the transparent cylindrical touch screen display 40 is transparent, wherein a user 18 can see through the reflector/beam splitter 38A, 38B, 38C, 38D and the transparent cylindrical touch screen display 40, as indicated at 48. This allows users 18 to perceive the floating image 36 at a distance beyond the reflectors/beam splitters 38A, 38B, 38C, 38D and further, allows the users 18 to see through the reflectors/beam splitters 38A, 38B, 38C, 38D and able to see the interior of the vehicle compartment and other users therein.

As shown in FIG. 4, the reflector/beam splitter 38A is shown, wherein the reflector/beam splitter 38A is moveable between a retracted position 50 and an extended position 52. In an exemplary embodiment, the reflector/beam splitter 38A is mounted onto a support shaft 54A that hangs down from the roof 28 of the vehicle compartment. In the retracted position 50, the reflector/beam splitter 38A is positioned adjacent to the display 34 and parallel to the roof 56 of the vehicle compartment. The reflector/beam splitter 38A is pivotal relative to the support shaft 54A, as indicated by arrow 58, and the support shaft 54A is extendable vertically up and down, as indicated by arrow 60. From the retracted position 50, the reflector/beam splitter 38A is pivoted down, and the support shaft 54A is extended downward to place the reflector/beam splitter 38A in the extended position 52 for use. When in the extended position 52, the reflector/beam splitter 38A is in operational proximity to the display 34 and a user 18 seated within the first seating position 20A.

Referring again to FIG. 4, the reflector/beam splitter 38B is shown, wherein the reflector/beam splitter 38B is mounted onto an armrest 62 next to the user 18 seated in the second seating position 20B. The reflector/beam splitter 38B is attached to a support shaft 54B that is attached to the armrest 62. While not shown, the reflector/beam splitter 38B supported on the armrest 62 may also be moveable from a retracted position to an extended position. In one exemplary embodiment, the reflector/beam splitter 38B is stowed within the armrest 62 when in the retracted position.

In an exemplary embodiment, an orientation of each of the plurality of reflectors/beam splitters 38A, 38B, 38C, 38D is fixed. Thus, when the reflectors/beam splitters 38A, 38B, 38C, 38D are in the extended position 52 angular orientation vertically and horizontally relative to the support shaft 54A, 54B is fixed. Alternatively, in another exemplary embodiment, an orientation of each of the plurality of reflectors/beam splitters 38A, 38B, 38C, 38D is adjustable. The reflector/beam splitter 38A, 38B, 38C, 38D may be pivotally mounted onto the support shaft 54A, 54B wherein the reflector/beam splitter 38A, 38B, 38C, 38D is pivotal horizontally, as indicated by arrow 64, and further, the reflector/beam splitter 38A, 38B, 38C, 38D may be pivotally mounted onto the support shaft 54A, 54B wherein the beam splitter 38A, 38B, 38C, 38D is vertically pivotal. Adjustability of the reflector/beam splitter 38A, 38B, 38C, 38D allows the reflector/beam splitter 38A, 38B, 38C, 38D to be positioned according to the position of the user 18 seated within the associated one of the plurality of seating positions 20A, 20B, 20C, 20D within the vehicle 14, and according to the height of the user 18, ensuring that the system 10 can be customized to accommodate users of different size and seating position/orientation preferences. In addition, adjustability of the orientation of the reflector/beam splitter 38A, 38B, 38C, 38D allows the perceived location of the floating image 36 to be adjusted according to the user's preferences.

In an exemplary embodiment, each of the plurality of reflectors/beam splitters 38A, 38B, 380, 38D is in communication with the occupant monitoring cameras 22A, 22B, 22C, 22D associated with each of the seating positions 20A, 20B, 20C, 20D, wherein an orientation of each of the plurality of reflectors/beam splitters 38A, 38B, 38C, 38D changes automatically in response to movement of the head and eyes of a user 18 seated within the associated seating position 20A, 20B, 20C, 20D.

Further details about the user display system 28, 32 shown in FIG. 4 are disclosed within U.S. patent application Ser. No. 17/842,272, Publication No. US-2023-0408841-A1, filed on Jun. 16, 2022 and entitled “MULTI-PERSPECTIVE THREE-DIMENSIONAL FLOATING IMAGE DISPLAY WITH TOUCH FUNCTION”, which is hereby incorporated by reference, in its' entirety, into the present disclosure.

Referring to FIG. 3 and FIG. 5, in another exemplary embodiment the user display system 28 comprising a single display system 32, further includes an image chamber 66 including the at least one display 34 adapted to project an image 36 and a plurality of reflectors 38A, 38B, 38C, 38D, one reflector individually associated with each one of the plurality of seating positions 20A, 20B, 20C, 20D within the vehicle 14 and adapted to reflect the image 36 to the associated one of the plurality of seating positions 20A, 20B, 20C, 20D within the vehicle 14, such that a user 18 seated at the associated one of the plurality of seating positions 20A, 20B, 20C, 20D within the vehicle 14 perceives the image 36 floating at a central location within the vehicle 14. The image chamber 66 includes transparent portions 68 adapted to allow the image 36 reflected by the reflectors 38A, 38B, 38C, 38D to pass from the image chamber 66 outward toward a user 18 seated at the associated one of the plurality of seating positions 20A, 20B, 20C, 20D. The image chamber 66 further includes solid portions 70 adapted to prevent light from entering the image chamber 66 behind the reflectors 38A, 38B, 38C, 38D.

The transparent cylindrical touch screen display 40 is positioned between the reflectors 38A, 38B, 38C, 38D of the image chamber 66 and the plurality of seating positions 20A, 20B, 20C, 20D within the vehicle 14, and adapted to display information to users 18 seated at the plurality of seating locations 20A, 20B, 20C, 20D within the vehicle 14 within an image plane 48, 50 positioned in front of the perceived image 36 floating at the central location within the vehicle 14.

Referring to FIG. 5, the image chamber 66 that includes a first display 34A that is adapted to project a first three-dimensional image 36A and a first reflector 38A individually associated with the first display 34A and a user 18 within the first seating position 20A, and a second display 34B that is adapted to project a second three-dimensional image 36B and a second reflector 38B individually associated with the second display 34B and a user 18 within the second seating position 20B. As shown in FIG. 5, for purposes of description herein, the user display system 28, 32 is shown only with the first and second seating positions 20A, 20B and first and second displays 34A, 34B, and first and second reflectors 38A, 38B. It should be understood that the user display system 28, 32 may be adapted to accommodate any suitable number of users 18 and corresponding seating positions 20A, 20B, 20C, 20D, such as shown in FIG. 3.

Referring to FIG. 3, the vehicle includes first, second, third and fourth seating positions 20A, 20B, 20C, 20D. Each reflector 38A, 38B, 38C, 38D is adapted to be viewed by a user 18 seated within one of the first, second, third and fourth seating positions 20A, 20B, 20C, 20D. Each reflector 38A, 38B, 38C, 38D is adapted to receive an image 36 from the associated display 34, and to reflect the image 36 to the associated seating position 20A, 20B, 20C, 20D for viewing by a user 18 seated therein. The users 18 perceive the image 36 floating at a central location within the image chamber 66.

Referring again to FIG. 5, the first reflector 38A is adapted to receive the first image 36A from the first display 34A, as indicated by arrows 72, and to reflect the first image 36A to the user 18 within the first seating position 20A, as indicated by arrows 74, wherein the user 18 within the first seating position 20A perceives the first image 36A floating at a central location within the image chamber 66, as indicated by arrows 76. The second reflector 38B is adapted to receive the second image 36B from the second display 34B, as indicated by arrows 78, and to reflect the second image 36B to the user 18 within the second seating position 20B, as indicated by arrows 80, wherein, the user 18 within the second seating position 20B perceives the second image 36B floating at the central location within the image chamber 66, as indicated by arrows 82.

Referring again to FIG. 3, each of the users 18 seated at the first, second, third and fourth seating positions 20A, 20B, 20C, 20D perceives an image 36 reflected to them by respective associated reflectors 38A, 38B, 38C, 38D and the users 18 perceive the image 36 reflected to them within the image chamber 66, as indicated by lines 84. Each of the displays 34 can project the same image 36 to each of the reflectors 38A, 38B, 38C, 38D and thus to each of the users at the first, second, third and fourth seating positions 20A, 20B, 20C, 20D. Alternatively, each of the displays 34 can display a different perspective of the same image, or a different image altogether to each of the reflectors 38A, 38B, 380, 38D. Thus the system 10 is capable of presenting the same floating image 36 to all of the seating positions 20A, 20B, 20C, 20D, so users 18 can view simultaneously, or alternatively, each user 18 at each seating position 20A, 20B, 20C, 20D can view a different perspective of the floating image 36 or a completely different three-dimensional image.

The transparent cylindrical touch screen display 40 is positioned between the plurality of seating positions 20A, 20B, 20C, 20D and the reflectors 38A, 38B, 38C, 38D. The transparent cylindrical touch screen display 40 is adapted to display information to the users 18 within an image plane 84, 86 positioned in front of the perceived first and second images 36A, 36B floating at the central location within the image chamber 66. The transparent cylindrical touch screen display 40 presents information to the user 18 seated within the first seating position 20A that appears within a first image plane 84, wherein information displayed on the transparent cylindrical touch screen display 40 to the user 18 within the first seating position 20A appears in front of the image 36A perceived by the user 18 within the first seating position 20A within the image chamber 66. The transparent cylindrical touch screen display 40 presents information to the user 18 within the second seating position 20B that appears within a second image plane 86, wherein information displayed on the transparent cylindrical touch screen display 40 to the user 18 within the second seating position 20B appears in front of the image 36B perceived by the user 18 within the second seating position 20B within the image chamber 66.

The transparent cylindrical touch screen display 40 is adapted to allow the users 18 seated within the plurality of seating positions 20A, 20B, 200, 20D to receive annotated information and to provide input to the system 10. The transparent cylindrical touch screen display 40 encircles the image chamber 66 and is thereby positioned between the eyes of users 18 seated within the plurality of seating positions 20A, 20B, 20C, 20D and the perceived image 36, 36A, 36B floating at the central location within the image chamber 66.

The transparent cylindrical touch screen display 40 is adapted to present visible displayed information only to the user 18 that is seated in a seating position 20A, 20B, 20C, 20D directly in front of a portion of the transparent cylindrical touch screen display 40. The nature of the transparent cylindrical touch screen display 40 is such that the displayed information is only displayed on a first side, the outward facing cylindrical surface, of the transparent cylindrical touch screen display 40. A second side, the inward facing cylindrical surface, of the transparent cylindrical touch screen display 40 does not display information, and thus, when viewed by the other users 18, allows the other users 18 to see through the transparent cylindrical touch screen display 40.

In one exemplary embodiment, the transparent cylindrical touch screen display 40 is an autostereoscopic display that is adapted to display stereoscopic, or three-dimensional images by adding binocular perception of three-dimensional depth without the use of special headgear, glasses, something that affects the viewer's vision, or anything for the viewer's eyes. Because headgear is not required, autostereoscopic displays are also referred to as “glasses-free 3D” or “glassesless 3D”.

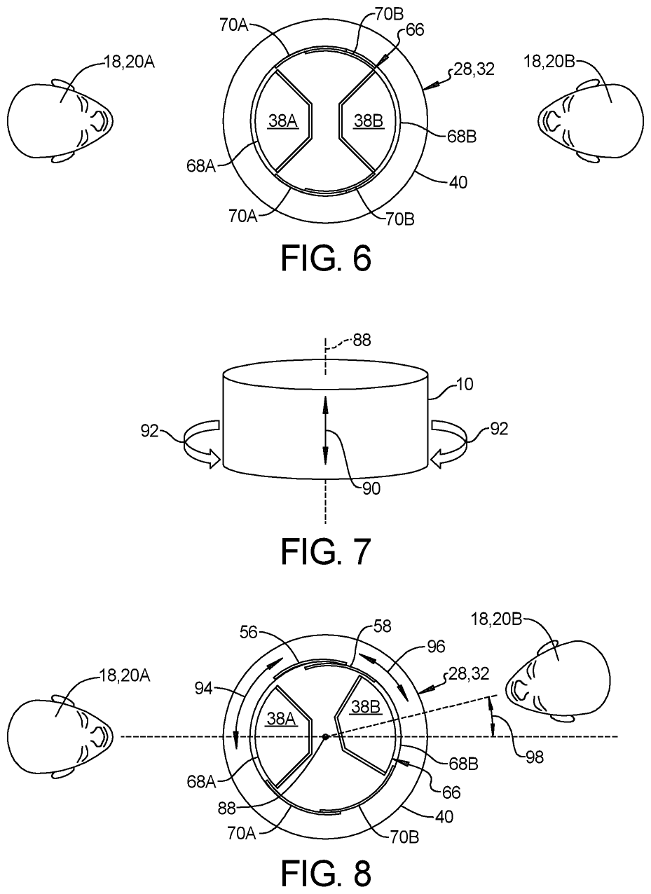

Referring to FIG. 6, the transparent portions 68 of the image chamber 66 allow users 18 to see their associated reflector 38A, 38B, 38C, 38D. As shown, the image chamber 66 includes a first transparent portion 68A that is adapted to allow the first image 36A reflected by the first reflector 38A to pass from the image chamber 66 outward toward the user 18 seated within the first seating position 20A, as indicated by arrows 74 in FIG. 5. Further, the image chamber 66 includes a second transparent portion 68B that is adapted to allow the second image 36B reflected by the second reflector 38B to pass from the image chamber 66 outward toward the user 18 seated within the second seating position 20B, as indicated by arrows 80 in FIG. 5.

The image chamber 66 further includes solid portions 70 that are adapted to prevent light from entering the image chamber 66 behind the first and second reflectors 38A, 38B. The image chamber 66 functions much like a Pepper's Ghost Chamber, wherein the image of an object is perceived by a viewer within a reflective surface adjacent the actual image. As discussed above, in the present disclosure, the image presented by a display which is not within view of a passenger 18, is reflected by a reflector 38A, 38B, 38C, 38D to the user 18 such that the user 18 “sees” the image 36 within the image chamber 66 and perceives the image 36 to be floating behind the reflective surface of the reflector 38A, 38B, 38C, 38D. If the image chamber 66 behind the reflectors 38A, 38B, 38C, 38D is exposed to ambient light, the image 36 will not be viewable by the users 18. Thus, the solid portions 70 of the image chamber 66 are adapted to prevent light from entering the image chamber 66 behind the first and second reflectors 38A, 38B. Referring to FIG. 6, the image chamber 66 includes solid overlapping panels 70A, 70B that are adapted to prevent light from entering the image chamber 66 behind the first and second reflectors 38A, 38B.

Referring to FIG. 7, in an exemplary embodiment, the user display system 28, 32 is selectively moveable vertically up and down along a vertical central axis 88, as indicated by arrow 90. Further, each display and the associated reflectors 38A, 38B, 38C, 38D are unitarily and selectively rotatable about the vertical central axis 88, as shown by arrows 92. This allows the system 10 to adjust to varying locations of the passengers 18 within the vehicle 14.

Referring to FIG. 8, the first reflector 38A and the first display 34A are rotatable about the vertical central axis 88, as indicated by arrow 94. The second reflector 38B and the second display 34B are rotatable about the vertical central axis 88, as indicated by arrow 96. As shown in FIG. 5, the users 18 are seated within the first and second seating positions 20A, 20B directly across from one another, and the first reflector 38A and first display 34A are positioned 180 degrees from the second reflector 38B and second display 34B. As shown in FIG. 8, the position of the head of the user 18 within the second seating position 20B has moved, and the second reflector 38B and the second display 34B have been rotated an angular distance 98 to ensure the user 18 within the second seating position 20B perceives the image 36B from the second display 34B and the second reflector 38B.

In an exemplary embodiment, the first solid panels 70A positioned adjacent the first reflector 38A on either side are adapted to move unitarily with the first reflector 38A and the first display 34A as the first reflector 38A and the first display 34A rotate about the vertical central axis 88. The second solid panels 70B positioned adjacent the second reflector 38B on either side are adapted to move unitarily with the second reflector 38B and the second display 34B as the second reflector 38B and the second display 34B rotate about the vertical central axis 88. The first solid panels 70A overlap the second solid panels 70B to allow relative movement of the first solid panels 70A relative to the second solid panels 70B and to ensure that ambient light is blocked from entering the image chamber 66 behind the first and second reflectors 38A, 38B at all times.

In an exemplary embodiment, each of the displays 34, 34A, 34B and associated reflectors 38A, 38B, 38C, 38D are in communication with the occupant monitoring cameras 22A, 22B, 22C, 22D, wherein an orientation of each display 34, 34A, 34B and associated reflector 38A, 38B, 38C, 38D changes automatically in response to movement of the head and eyes of a user 18 detected by the occupant monitoring cameras 22A, 22B, 22C, 22D.

In an exemplary embodiment, the user display system 28, 32 receives data from the first occupant monitoring camera 22A related to the position of the head and eyes of the user seated within the first seating position 20A. The first display 34A and first reflector 38A are adapted to rotate in response to movement of the head and eyes of the user 18 based on data received from the first occupant monitoring camera 22A. The user display system 28, 32 further receives data from the second occupant monitoring camera 22B related to the position of the head and eyes of the user seated within the second seating position 20B. The second display 34B and second reflector 38B are adapted to rotate in response to movement of the head and eyes of the user 18 based on data received from the second occupant monitoring camera 22B. In addition to rotation of the first display 34A and first reflector 38A and the second display 34B and second reflector 38B, the user display system 28, 32 is adapted to move up and down along the vertical central axis 88, as shown in FIG. 7, in response to movement of the head and eyes of the users 18 within the first and second seating positions 20A, 20B.

Further details about the user display system shown in FIGS. 5-8 are disclosed within U.S. patent application Ser. No. 18/153,767, filed on Jan. 12, 2023 and entitled “ADAPTIVE INTERACTIVE CAMPFIRE DISPLAY”, which is hereby incorporated by reference, in its' entirety, into the present disclosure.

In another exemplary embodiment, the system 10 includes audio devices, such as at least one microphone 24 to allow a user 18 to provide audible input to the system 10. The system 10 may include a microphone 24 adapted to receive audible input from any user 18 within the vehicle 14 and/or a microphone 24 that is specifically associated with one of the first, second, third and fourth seating positions 20A, 20B, 20C, 20D and adapted to pick up audible input only from the user 18 seated within the associated one of the first, second, third and fourth seating positions 20A, 20B, 20C, 20D.

In an exemplary embodiment, the user display system 28 is adapted to accept input from a user 18 based solely on contact between the user 18 and the user display system 28. For example, when a user 18 reaches out to touch a finger-tip to the touch screen display 40, the touch screen display 40 takes the input based solely on the point of contact between the tip of the finger of the passenger 18 and the transparent touch screen display 40.

In another exemplary embodiment, the system 10 is adapted to accept input from a user 18 based on contact between the user 18 and the touch screen display 40 and based on the location of a point of contact between the user 18 and the touch screen display 40 relative to the perceived image 36. For example, the occupant monitoring cameras 22A, 22B, 22C, 22D track the movement and position of the user's 18 eyes and head. The touch screen display 40 displays information that is perceived by the user 18 relative to the floating image 36, as discussed above. When the user 18 touches the touch screen display 40, the user 18 perceives that they are touching the floating image 36. The user display system 10 uses parallax compensation to correlate the actual point of contact between the finger-tip of the user 18 on the touch screen display 40 to the location on the floating image 36 that the user 18 perceives they are touching.

The user display system 28 may display, on the touch screen display 40, multiple different blocks of annotated information relative to a floating image 36. As the user's 18 head and eyes move, the user's head and eyes will be positioned at a different distance and angle relative to the touch screen display 40, thus changing the perceived location of displayed information relative to the image 36. By using parallax compensation techniques, such as disclosed in U.S. Pat. No. 10,318,043 to Seder, et al., hereby incorporated by reference herein, the user display system 28 ensures that when the user 18 touches the touch screen display 40, the user display system 28 correctly identifies the intended piece of annotated information that the user 18 is selecting.

In another exemplary embodiment, the user display system 28 is adapted to accept input from a user 18 based on gestures made by the user 18 where the user 18 does not touch the touch screen display 40. For example, when the user 18 moves a hand, or points to an object that is displayed on the touch screen display 40 or to an object within the vehicle compartment or outside of the vehicle 14.

Referring again to FIG. 5, using the embodiment of the user display system 28, 32 shown therein, in an exemplary embodiment, the user display system 28 includes a first gesture sensor 110 adapted to monitor position and movement of arms, hands and fingers 114 of the user 18 seated within the first seating position 20A and to gather data related to gestures made by the user 18. The first gesture sensor 110 is incorporated into or with the first occupant monitoring camera 22A and may include a separate camera and/or motion sensors adapted to detect the position and movement of the user 18 seated within the first seating position's 20A arms, hands and fingers. Further, the user display system 28 includes a second gesture sensor 112 adapted to monitor position and movement of arms, hands and fingers of the user 18 seated within the second seating position 20B and to gather data related to gestures made by the user 18. The second gesture sensor 112 is incorporated into or with the second occupant monitoring camera 22B and may include a separate camera and/or motion sensors adapted to detect the position and movement of the arms, hands and fingers of the user 18 seated within the second seating position 20B.

The vehicle display server uses data collected by the first and second gesture sensors 110, 112 to identify gestures made by the users 14A, 14B within the vehicle, using computer vision and computer learning algorithms and parallax compensation techniques to interpret such gestures and identify input data.

In an exemplary embodiment, the vehicle display server 12 is adapted to identify, using the plurality of sensors 16 positioned within the vehicle 14, computer vision algorithms and stored data, an identity of a user 18 seated at a one of the plurality of seating positions 20A, 20B, 20C, 20D within the vehicle 14. Once the vehicle display server 12 identifies the user 18, the vehicle display server 12 selects user specific content to be displayed for the user 18 on the user display system 28. User specific content may include applications or accounts for which the user 18 has previously registered and accesses with the system 10 regularly. For example, a user 18 regularly, when using the system 10 within the vehicle 14, watches a streamed news service. Thus, when the vehicle display server 12 identifies the user 18, the vehicle display server 12 will select the streamed news service as user specific content that may be displayed for the user 18. User specific content may also include contextual based content, such as, for example, if local weather services are calling for very bad storms in the near future, the vehicle display server 12 may tag weather information services as user specific content that will be displayed for the user 18 to inform the user of the upcoming bad weather. User specific content may also be based on probabilistic calculations with a machine learning algorithm of what content the user 18 may want based on stored data taking into consideration time of day/night, destination, number of passengers in the vehicle with the user 18, identity of the other passengers within the vehicle 14, etc. User specific content may also include any content that a user 18 has selectively chosen to be displayed.

Once the vehicle display server 12 has selected, using the identity of the user 18, user specific content to be displayed for the user 18, the vehicle display server 12 automatically displays the user specific content on the user display system 28 for the seating position 20A, 20B, 20C, 20D wherein the user 18 sits. Automatic display of user specific content will be dependent upon the system 10 identifying the user 18, and the user 18 being registered with the system 10 and agreeing to terms and conditions associated with use of the system 10. If the system 10 identifies the user 18 as a registered user of the system 10, the system will automatically initiate display of user specific content selected for that user 18. The vehicle display server 12 may display multiple options of various items that are included in the user specific content, or may, based on probabilistic calculations automatically prioritize different items of user specific content and display the highest ranked item. For example, a user 18 may be watching a movie on the user display system 28 within the vehicle 14, when the vehicle 14 arrives at a destination, wherein the user 18 terminates display of the movie and exits the vehicle 14. When the user 18 returns to the vehicle 14, the vehicle display server 12 will prioritize the movie and automatically resume displaying the movie for the user 18 on the user display system 28 directed to the seating position 20A, 20B, 20C, 20D where the user 18 sits.

In an exemplary embodiment, the vehicle display server 12 is adapted to detect when the user 18 is no longer viewing the user specific content on the user display system 28, and automatically terminate display of the user specific content and automatically log-out from the user specific content when the user 18 is no longer viewing the user specific content on the user display system 28. User specific content may include personal information that a user 18 would not want other passengers within the vehicle 14 to see or be able to access, thus, when the user 18 is no longer looking at the user display system 28, the vehicle display server 12 automatically terminates the display of user specific content and logs the user out of any accounts or applications for which the user 18 logged into on the user display system 28. This prevents a user 18 from inadvertently leaving personal user specific content displayed when they are no longer viewing it.

In an exemplary embodiment, the vehicle display server 12 is further adapted to detect when the user 18 has looked away from the user display system 28 and is still seated within the first one 20A of the plurality of seating positions 20A, 20B, 20C, 20D within the vehicle 14. When this occurs, the vehicle display server 12 pauses display of the user specific content for the user 18 on the user display system 28, and, when a pre-determined amount of time has passed, terminates display of the user specific content and automatically logs-out from the user specific content. The pre-determined amount of time is determined to be an amount of time that the user 18 may look away from the user display system 28 without interruption of the displayed user specific content. For instance, the pre-determined amount of time may be ten seconds, thus, if the user 18 looks away from the user display system 28 for just a moment to reach for a personal item or to look briefly out a window, the display of user specific content continues un-interrupted. However, if the user 18 looks away from the user display 28 and becomes distracted by something they see through the window, and they remain looking away from the user display system 28 for more than ten seconds, the vehicle display server 12, automatically terminates the display and logs the user out of any applications or accounts that the user was previously accessing via the user display system 28.

In another exemplary embodiment, when a user 18 seated at the first seating position 20A within the vehicle 14 moves away from the first seating position 20A within the vehicle 14, the vehicle display server 12 is adapted to detect, with the plurality of sensors 16 positioned within the vehicle 14, such as the first occupant monitoring camera 22A, when the user 18 leaves the first seating position 20A within the vehicle 14. When the vehicle display server 12 detects the user 18 has left the first seating position 20A, the vehicle display server 12 automatically pauses the user specific content that is currently being displayed on the user display system 28 for the first seating position 20A.

As discussed above, if a pre-determined amount of time, such as ten seconds, passes and the user 18 has not returned to the first seating position 20A, then the vehicle display server 12 terminates display of the user specific content and automatically logs-out from the user specific content that was being displayed on the user display system 28 for the first seating position 20A. If the user 18 returns to the first seating position 20A, within the pre-determined amount of time, then the vehicle display server will resume the displayed user specific content on the user display system 28 for the first seating position 20A.

If, after the user 18 moves away from the first seating position 20A, and while the user specific content displayed on the user display system 28 for the first seating position 20A is paused, the vehicle display server 12 detects, with the plurality of sensors 16 positioned within the vehicle 14, such as the second occupant monitoring camera 22B, that the user 18 has sit at the second seating position 20B within the vehicle 14, the vehicle display server 12 automatically terminates display of the user specific content and automatically logs-out from the user specific content that was being displayed on the user display system 28 for the first seating position 20A.

If, after the user 18 moves away from the first seating position 20A, and while the user specific content displayed on the user display system 28 for the first seating position 20A is paused, a different passenger sits at the first seating position 20A, the vehicle display server 12 automatically terminates display of the user specific content and automatically logs-out from the user specific content that was being displayed on the user display system 28 for the first seating position 20A. This prevents a different passenger from seeing user specific content for the user 18 or from being able to access accounts that the user 18 may have been accessing via the user display system 28 before the user 18 left the first seating position 20A.

If the vehicle display server 12, using the plurality of sensors 16 positioned within the vehicle 14, detects that, after the user 18 moves away from the first seating position 20A, and while the user specific content displayed on the user display system 28 for the first seating position 20A is paused, that the user 18 has exited the vehicle 14, the vehicle display server 12 automatically terminates display of the user specific content and automatically logs-out from the user specific content that was being displayed on the user display system 28 for the first seating position 20A.

In an exemplary embodiment, the vehicle display server 12 is adapted to detect, with the plurality of sensors 16, when the user 18 seated within the first seating position 20A within the vehicle 14, moves away from the first seating position and has left at least one personal object 154A, 154B, 154C, 154D that the vehicle display server 12 has associated with the user 18, at the first seating position 20A. When this occurs, the vehicle display server 12 is adapted to provide an alert for the user 18 to notify the user 18 that at least one personal object 154A, 154B, 154C, 154D associated with the user 18 has been left within the first seating position 20A. Thus, referring again to FIG. 10, if the user 18 moves within the vehicle 14, and forgets to take the duffel bag 154C with them, the vehicle display server 12 will provide an alert.

In another exemplary embodiment, the vehicle display server 12 is adapted to detect, with the plurality of sensors 16, when the user 18 seated within the first seating position 20A within the vehicle 14, moves away from the first seating position 20A and takes a personal object that the vehicle display server 12 has associated with a different passenger within the vehicle 14. For example, if the user 18 grabs a pair of sunglasses that are sitting on a bench seat between the user 18 and another passenger sitting at adjacent seating positions, but the sunglasses were placed there by the other passenger and have been associated to the other passenger by the vehicle display server 12, the vehicle display server 12 will provide an alert for the user 18 to notify the user 18 that the user 18 has taken a personal item that does not belong to them.

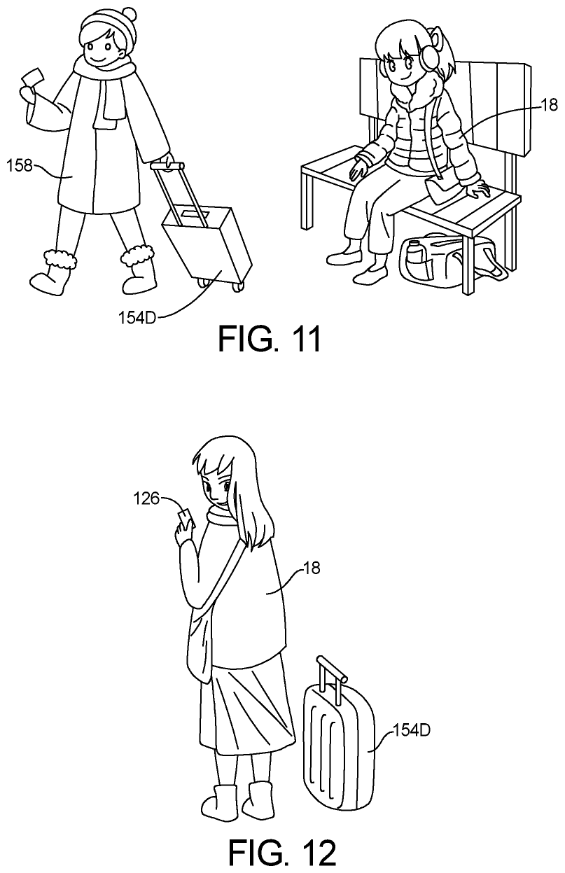

In another exemplary embodiment, the vehicle display server 12 is adapted to detect, with the plurality of sensors 16, when a different passenger 158 within the vehicle 14 has moved within the vehicle 14 and has taken a personal object 154A, 154B, 154C, 154D that is associated with the user 18. For example, referring to FIG. 11, when a different passenger 158 inadvertently takes the suitcase 154D belonging to the user 18, the vehicle display server 12, using the plurality of sensors 16, detects that the other passenger 158 has taken the personal object 154D that has been associated with the user 18. When this occurs, the vehicle display server 12 will provide an alert for the user 18 to notify the user 18 that a different passenger 158 has taken a personal object 154D that belongs to the user 18.

Alerts may be provided to the user 18 by various different methods. In an exemplary embodiment, when the vehicle display server 12 provides an alert to the user 18, the alert comprises an audible chime or bell, or verbal voice communication provided by artificial intelligence software within the vehicle display server 12. Such audible alerts may be broadcast generally within the vehicle 14, wherein they are heard by all passengers within the vehicle 14, or such audible alerts may be broadcast, such as by directional speakers, specifically to the user 18. In another exemplary embodiment, when the vehicle display server 12 provides an alert to the user 18, the alert comprises user specific graphics and textual messages displayed on the user display system 28 for the seating position 20A, 20B, 20C, 20D at which the user 18 is seated. For example, referring again to FIG. 11, when the other passenger 158 takes the suitcase 154D belonging to the user 18 seated at the first seating position 20A, the vehicle display system 12 may display a message on the user display system 28 for the first seating position 20A, including a warning graphic and/or a textual message, such as “Check Belongings!” to prompt the user 18 to check their personal objects 154A, 154B, 154C, 154D and hopefully realize that the other passenger 158 has inadvertently taken the suitcase 154D associated with the user 18.

In another exemplary embodiment, when the vehicle display server 12 provides an alert to the user 18, the alert comprises a haptic alert provided by the plurality of haptic devices 26A, 26B, 26C, 26D within the vehicle. For example, referring again to FIG. 11, when the other passenger 138 takes the suitcase 134D belonging to the user 18 seated at the first seating position 20A, the vehicle display system 12 may actuate the first haptic devices 26A associated with the first seating positions to provide haptic feedback to the user 18 seated at the first seating position 20A. Haptic feedback may includes, for example, vibration of a seat cushion or arm rest at the first seating position 20A to get the user's 18 attention. Haptic feedback may be particularly useful in a situation where the user 18 is distracted or sleeping.

In another exemplary embodiment, when the vehicle display server 12 provides an alert to the user 18, the alert comprises disabling doors of the vehicle 14. For example, in a circumstance where the user 18 has left a personal object 154A, 154B, 154C, 154D behind, and the vehicle display server 12 detects that the user 18 is moving toward a door of the vehicle 14 and intends to exit the vehicle 14, the vehicle display server 12, via communication with other systems within the vehicle 14, can selectively disable the vehicle 14 doors, preventing the user 18 from leaving without the personal object they left behind. Further, referring again to FIG. 11, when the other passenger 158 takes the suitcase 154D belonging to the user 18 seated at the first seating position 20A, the vehicle display server 12, via communication with other systems within the vehicle 14, can selectively disable the vehicle 14 doors, preventing the other passenger 158 from leaving the vehicle 14 with the personal object 154D belonging to the user 18. Disabling the vehicle 14 doors along with other audible, haptic and/or visual alerts, will prevent the user 18 and other passengers 158 from leaving the vehicle 14 until they get their personal objects sorted out.

In another exemplary embodiment, the system 10 includes a personal device 126 of the user 18 that is registered with and linked to the system 10 and in communication, via the wireless network 122, with the vehicle display server 12, and alerts provided by the vehicle display server 12 include alerts sent to the user's 18 personal device 126. For example, a user 18 that is registered to use the system 10 may have an app that allows the personal device 126, such as a phone or tablet, to be linked to the system 10. Referring to FIG. 12, when the user 18 attempts to leave the vehicle 14 and leaves the suitcase 134D behind, the vehicle display server 12 sends an alert to the personal device 126 of the user 18, prompting the user 18 to look back for the suitcase 134D. The personal device 126 may be a cell phone, tablet or smart watch and the alert sent to the personal device 126 may be an audible chime, text message and/or haptic feedback, such as vibration.

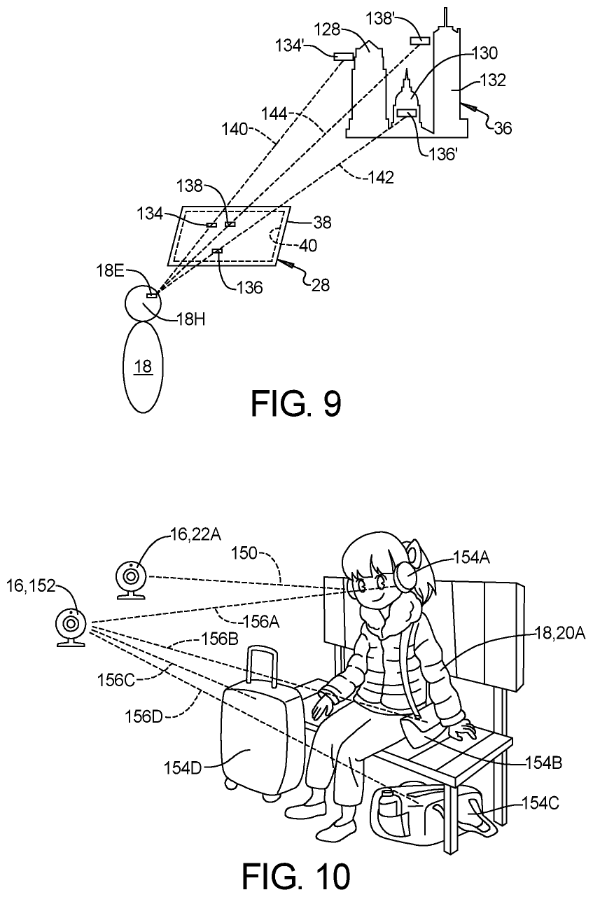

Referring to FIG. 9, in a schematic view of a user 18 viewing a user display system 28 including an associated reflector 38, a transparent touch screen display 40, and a floating image 36, the user 18 perceives the floating image 36 at a distance in front of the reflector 38. As shown, the user display system 28 includes a transparent touch screen display 40 incorporated into the reflector 38 for each individual user 18. These principles apply similarly to a user display system 28 incorporating individual reflectors and a transparent cylindrical touch screen display 40 as well.

The transparent touch screen display 40 displays information related to the floating image 36 at a proper location on the transparent touch screen display 40 the user 18 sees the information at a proper location relative to the floating image 36. As shown in FIG. 9, the floating image 36 is of a skyline, and more specifically, of three buildings, a first building 128, a second building 130, and a third building 132. The transparent touch screen display (or the transparent cylindrical touch screen display) 40 displays first building information 134, second building information 136 and third building information 138.

The first building information 134 appears in a text box and may contain information about the first building 128 as well as the option of allowing the user 18 to touch the first building information 134 text box to acquire additional information about the first building 128. For example, the first building information 134 text box may contain the name of the first building 128 and the street address. The passenger 18 may opt to touch the first building information 134 text box, wherein additional information will appear on the transparent touch screen display 40, such as the date the first building 128 was built, what type of building (office, church, arena, etc.), or statistics such as height, capacity, etc. The second building information 136 and the third building information 138 also appear in text boxes that contain similar information and the option for the user 18 to touch the second or third building information 136, 138 text boxes to receive additional information about the second and third buildings 130, 132.

The occupant monitoring cameras 22A, 22B, 22C, 22D track the position of the user's 18 head 18H and eyes 18E and positions the first, second and third building information 134, 136, 138 text boxes at a location on the transparent touch screen display 40, such that when the user looks at the floating image 36 through the reflector/beam splitter 38 and the transparent touch screen display (transparent cylindrical touch screen display) 40, the user 18 sees the first, second and third building information 134, 136, 138 text boxes at the proper locations relative to the floating image 36. For example, the transparent touch screen display (transparent cylindrical touch screen display) 40 positions the first building information 134 in the user's line of sight, as indicated by dashed line 140, such that the first building information 134 is perceived by the user 18 at a location immediately adjacent the first building 128, as indicated at 134′. Correspondingly, the transparent touch screen display (transparent cylindrical touch screen display) 40 positions the second building information 136 in the user's line of sight, as indicated by dashed line 142, and the third building information 138 in the user's line of sight, as indicated by dashed line 144, such that the second and third building information 136, 138 is perceived by the user 18 at a location superimposed on the building, in the case of the second building 130, as indicated at 136′, and at a location immediately adjacent the building, in the case of the third building 132, as indicated at 138′.

The occupant monitoring cameras 22A, 22B, 22C, 22D continuously track movement of the head 18H and eyes 18E of the user 18 and adjusts the position that the first, second and third building information 1234, 136, 138 are displayed on the transparent touch screen display (transparent cylindrical touch screen display) 40 to ensure that the user 18 always perceives the first, second and third building information 134, 136, 138 at the proper locations 134′, 136′, 138′ relative to the floating image 36.

In an exemplary embodiment, when using the identity of the user seated within the vehicle 14 to select user specific content to be displayed for the user, the vehicle display server 12 is adapted to access stored historical data of past content viewed by the user 18, such data being stored within the vehicle display server 12 within the vehicle 14 and/or within a cloud-based database 146 within and/or in communication with the host server 120. The vehicle display server 12 may further prompt the user 18 to selectively resume viewing content that the user 18 was previously viewing on a different user display system, and/or prompt a user 18 to selectively view content that is already being viewed by other users within the same vehicle 14.

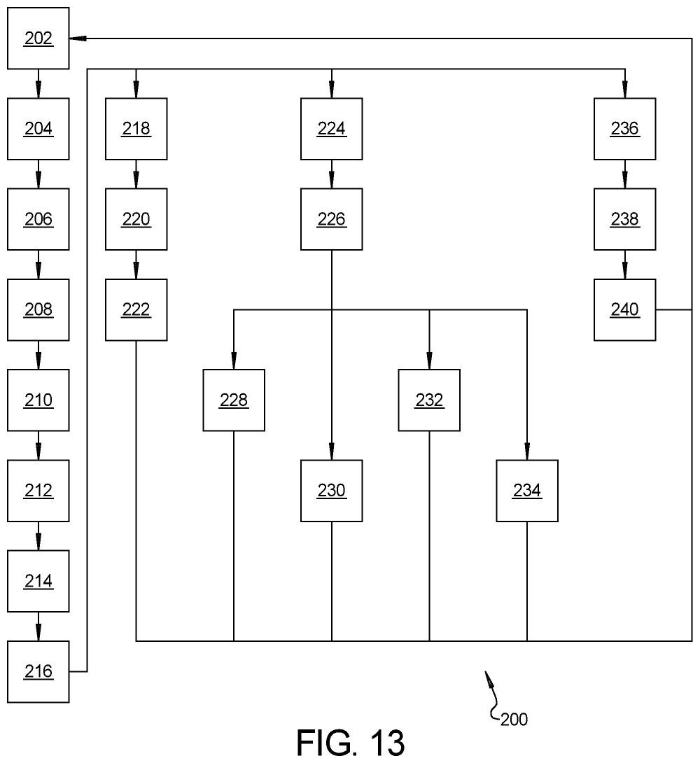

Referring to FIG. 13, a method 200 of automatically logging a user out of user specific content displayed within a system 10 within a vehicle 14 having a vehicle display system 28 and a vehicle display server 12 positioned within the vehicle 14 and in communication with a plurality of sensors 16 positioned within the vehicle 14 and adapted to track head and eye position and movement of users 18 seated within a plurality of seating positions 20A, 20B, 20C, 20D within the vehicle 14, detect locations of users 18 within the vehicle 14 and when users 18 change seating positions within the vehicle 14, detect when a user 18 enters and exits the vehicle 14, detect personal objects that are brought into the vehicle 14 by a user 18, haptic feedback devices 26A, 26B, 26C, 26D positioned within the vehicle 14 and adapted to provide haptic feedback to users 18 seated within the vehicle 14, and a user display system 28 positioned within the vehicle 14 for viewing and interaction by users 18 seated within the plurality of seating positions 20A, 20B, 20C, 20D within the vehicle 14, the method 200 including, with the vehicle display server 12, moving to block 202, detecting when a user 18 enters the vehicle 14, moving to block 204, identifying, using the plurality of sensors 16 positioned within the vehicle 14, computer vision algorithms and stored data, an identity of the user 18, moving to block 206, detecting, using the plurality of sensors 16 positioned within the vehicle 14, a first one of the plurality of seating positions 20A, 20B, 20C, 20D within which the user 18 sits, moving to block 208, detecting, using the plurality of sensors 16 positioned within the vehicle 14, personal objects 154A, 154B, 154C, 154D brought into the vehicle 14 by the user 18, moving to block 210, associating, using artificial intelligence and machine learning algorithms, the detected personal objects 154A, 154B, 154C, 154D, with the user 18, moving to block 212, displaying user specific content on the user display system 28 for viewing by the user 18, moving to block 214, detecting when the user 18 is no longer viewing the user specific content on the user display system 28, and, moving to block 216, automatically terminating display of the user specific content and automatically logging-out from the user specific content when the user 18 is no longer viewing the user specific content on the user display system 28.

In an exemplary embodiment, the method 200 further includes, moving to block 218, detecting when the user 18 has looked away from the user display system 28 and is still seated within the first one 20A of the plurality of seating positions 20A, 20B, 20C, 20D within the vehicle 14, moving to block 220, pausing display of the user specific content for the user on the user display system 28, and, moving to block 222, when a pre-determined amount of time has passed, terminating display of the user specific content and automatically logging-out from the user specific content.

In an exemplary embodiment, the method 200 further includes, moving to block 224, detecting when the user 18 has moved away from the one 20A of the plurality of seating positions 20A, 20B, 20C, 20D within the vehicle 14, moving to block 226, pausing display of the user specific content for the user 18 on the user display system 28 at the first one 20A of the plurality of seating positions 20A, 20B, 20C, 20D, and, at least one of: moving from block 226 to block 228, when a pre-determined amount of time has passed, automatically terminating display of the user specific content and automatically logging-out from the user specific content that is being displayed on the user display system 28 at the first one 20A of the plurality of seating positions 20A, 20B, 20C, 20D; moving from block 226 to block 230, detecting, with the plurality of sensors 16, that the user 18 has moved to a second one 20B of the plurality of seating positions 20A, 20B, 20C, 20D, and automatically terminating display of the user specific content and automatically logging-out from the user specific content that is being displayed by the user display system 28 at the first one 20A of the plurality of seating positions 20A, 20B, 20C, 20D; moving from block 226 to block 232, detecting, with the plurality of sensors 16, that another passenger has moved into the first one 20A of the plurality of seating positions 20A, 20B, 20C, 20D, and automatically terminating display of the user specific content and automatically logging-out from the user specific content that is being displayed by the user display system 28 at the first one 20A of the plurality of seating positions 20A, 20B, 20C, 20D; and, moving from block 226 to block 234, detecting, with the plurality of sensors 16, that the user 18 has exited the vehicle 14, and automatically terminating display of the user specific content and automatically logging-out from the user specific content that is being displayed by the user display system 28 at the first one 20A of the plurality of seating positions 20A, 20B, 20C, 20D.

In another exemplary embodiment, the method 200 further includes, with the vehicle display server 12, moving from block 216 to block 236, detecting, with the plurality of sensors 16, when the user 18 has moved away from the first one 20A of the plurality of seating positions 20A, 20B, 20C, 20D and has left at least one personal object 154A, 154B, 154C, 154D associated with the user 18 at the first one 20A of the plurality of seating positions 20A, 20B, 20C, 20D, and providing an alert for the user 18 to notify the user 18 that at least one personal object 154A, 154B, 154C, 154D associated with the user 18 has been left within the first one 20A of the plurality of seating positions 20A, 20B, 20C, 20D, moving to block 238, detecting, with the plurality of sensors 16, when the user 18 has moved away from the first one 20A of the plurality of seating positions 20A, 20B, 20C, 20D and has taken at least one personal object associated with a different passenger, and providing an alert for the user 18 to notify the user 18 that the user 18 has taken at least one personal object associated with a different passenger, and, moving to block 240, detecting, with the plurality of sensors 16, when a different passenger 158 within the vehicle 14 has moved from one of the plurality of seating positions 20A, 20B, 20C, 20D within the vehicle 14 and has taken at least one personal object 154A, 154B, 154C, 154D associated with the user 18, and providing an alert for the user 18 to notify the user 18 that another passenger 158 has taken at least one personal object 154A, 154B, 154C, 154D associated with the user 18.

In an exemplary embodiment, the providing an alert by the vehicle display server 12 at blocks 236, 238 and 240 includes at least one of providing an audible chime or bell, providing verbal alerts broadcast generally within the vehicle, providing directional verbal alerts, broadcast specifically to the user 18, providing user specific graphics and textual messages displayed on the user display system 28, providing user specific haptic alerts with the plurality of haptic devices 26A, 26B, 26C, 26D within the vehicle 14, and disabling doors of the vehicle 14.

In an exemplary embodiment, wherein the system 10 further includes a personal device 126 of the user 18 that is registered with and linked to the system 10, wherein, the providing an alert by the vehicle display server 12 at blocks 236, 238 and 240 further includes sending an alert to the user's personal device 126.

A system and method of the present disclosure offers several advantages. These include providing a floating image that is perceived by the passengers at a centrally location position within the vehicle compartment. This provides a camp-fire like viewing atmosphere where the passengers can all view a common floating image, or each passenger can view a unique floating image. Further, a system in accordance with the present disclosure provides the ability to display annotations and information not embedded within the virtual image and to ensure such annotations and information are perceived by a passenger at a proper location relative to the virtual image and in a plane between the passenger and the floating image. The system enables interaction between multiple users that are located within the same vehicle or within different vehicles and provides automatic identification of a user and selection/display of content specific to that user and displayed specifically to a seating position within a vehicle where the user is sitting. The system further enables such selected user specific content to follow a user moving from one seating position to another within a vehicle or moving from one vehicle to a different vehicle.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A system for automatically logging a user out of user specific content displayed on a vehicle display, comprising:
a vehicle display server positioned within a vehicle and in communication with:
a plurality of sensors positioned within the vehicle and adapted to:
track head and eye position and movement of users seated within a plurality of seating positions within the vehicle;
detect locations of users within the vehicle and when users change seating positions within the vehicle;
detect when a user enters and exits the vehicle;
detect personal objects that are brought into the vehicle by a user;
haptic feedback devices positioned within the vehicle and adapted to provide haptic feedback to users seated within the vehicle; and
a user display system positioned within the vehicle for viewing and interaction by users seated within the plurality of seating positions within the vehicle;
the vehicle display server adapted to:
detect when a user enters the vehicle;
identify, using the plurality of sensors positioned within the vehicle, computer vision algorithms and stored data, an identity of the user;
detect, using the plurality of sensors positioned within the vehicle, a first one of the plurality of seating positions within which the user sits;
detect, using the plurality of sensors positioned within the vehicle, personal objects brought into the vehicle by the user;
associate, using artificial intelligence and machine learning algorithms, the detected personal objects, with the user;
display user specific content on the user display system for viewing by the user;
detect when the user is no longer viewing the user specific content on the user display system; and
automatically terminate display of the user specific content and automatically log-out from the user specific content when the user is no longer viewing the user specific content on the user display system.

2. The system of claim 1, wherein the vehicle display server is further adapted to:
detect when the user has looked away from the user display system and is still seated within the first one of the plurality of seating positions within the vehicle;
pause display of the user specific content for the user on the user display system; and
when a pre-determined amount of time has passed, terminate display of the user specific content and automatically log-out from the user specific content.

3. The system of claim 2, wherein the vehicle display server is further adapted to:
detect when the user has moved away from the one of the plurality of seating positions within the vehicle;
pause display of the user specific content for the user on the user display system at the first one of the plurality of seating positions; and at least one of:
when a pre-determined amount of time has passed, automatically terminate display of the user specific content and automatically log-out from the user specific content that is being displayed on the user display system at the first one of the plurality of seating positions;
detect, with the plurality of sensors, that the user has moved to a second one of the plurality of seating positions, and automatically terminate display of the user specific content and automatically log-out from the user specific content that is being displayed by the user display system at the first one of the plurality of seating positions;
detect, with the plurality of sensors, that another passenger has moved into the first one of the plurality of seating positions, and automatically terminate display of the user specific content and automatically log-out from the user specific content that is being displayed by the user display system at the first one of the plurality of seating positions; and
detect, with the plurality of sensors, that the user has exited the vehicle, and automatically terminate display of the user specific content and automatically log-out from the user specific content that is being displayed by the user display system at the first one of the plurality of seating positions.

4. The system of claim 3, wherein the vehicle display server is further adapted to:
detect, with the plurality of sensors, when the user has moved away from the first one of the plurality of seating positions and has left at least one personal object associated with the user at the first one of the plurality of seating positions; and
provide an alert for the user to notify the user that at least one personal object associated with the user has been left within the first one of the plurality of seating positions.

5. The system of claim 4, wherein the vehicle display server is further adapted to:
detect, with the plurality of sensors, when the user has moved away from the first one of the plurality of seating positions and has taken at least one personal object associated with a different passenger; and
provide an alert for the user to notify the user that the user has taken at least one personal object associated with a different passenger.

6. The system of claim 5, wherein the vehicle display server is further adapted to:
detect, with the plurality of sensors, when a different passenger within the vehicle has moved from one of the plurality of seating positions within the vehicle and has taken at least one personal object associated with the user; and
provide an alert for the user to notify the user that another passenger has taken at least one personal object associated with the user.

7. The system of claim 6, wherein, the alert provided by the vehicle display server includes at least one of:
an audible chime or bell;
verbal alerts broadcast generally within the vehicle;
directional verbal alerts, broadcast specifically to the user;
user specific graphics and textual messages displayed on the user display system;
user specific haptic alerts provided by the plurality of haptic devices within the vehicle; and
disabling doors of the vehicle.

8. The system of claim 7, further including a personal device of the user that is registered with and linked to the system, wherein alerts provided by the vehicle display server include alerts sent to the user's personal device.

9. The system of claim 1, wherein the user display system comprises one of:
a plurality of individual display screens adapted to display information and receive input from a user, one individual display screen associated with each of the plurality of seating positions within the vehicle; or
a single display system comprising:
at least one display for projecting an image;
a plurality of reflectors, each reflector associated with a one of the plurality of seating positions within the vehicle and adapted to reflect a projected image to the associated one of the plurality of seating positions, such that a user seated at the associated one of the plurality of seating positions within the vehicle perceives the image floating at a central location within the vehicle; and
a transparent cylindrical touch screen display positioned between the plurality of seating positions within the vehicle and the plurality of reflectors and adapted to display user specific content for users at each of the plurality of seating positions within the vehicle and receive input from each of the users at each of the plurality of seating positions within the vehicle.

10. The system of claim 9, wherein for the user display system comprising a single display system, the plurality of reflectors comprises a plurality of transparent beam splitters, one transparent beam splitter individually associated with each one of the plurality of seating positions within the vehicle, each beam splitter adapted to receive an image from the at least one display and to reflect the image to the associated one of the plurality of seating positions, wherein, a user seated at the associated one of the plurality of seating positions within the vehicle perceives the image floating at a central location within the vehicle.

11. The system of claim 9, wherein for the user display system comprising a single display system, the user display system further includes:
an image chamber including:
at least one display adapted to project an image;
a reflector individually associated with each one of the plurality of seating positions within the vehicle and adapted to reflect the image to the associated one of the plurality of seating positions within the vehicle, such that a user seated at the associated one of the plurality of seating positions within the vehicle perceives the image floating at a central location within the vehicle;
transparent portions adapted to allow the image reflected by the reflector to pass from the image chamber outward toward a user seated at the associated one of the plurality of seating positions; and
solid portions adapted to prevent light from entering the image chamber behind the reflector; and
the transparent cylindrical touch screen display is positioned between the reflectors of the image chamber and the plurality of seating positions within the vehicle, and adapted to display information to users seated at the plurality of seating locations within the vehicle within an image plane positioned in front of the perceived image floating at the central location within the vehicle.

12. The system of claim 1, further including a cloud-based host server in communication, via a wireless communication network, with the vehicle display server within the vehicle, the cloud-based host server adapted to receive and store historical data related to past instances of identification of the user by the vehicle display server within the vehicle and by other vehicles linked to the system and association of personal objects with the user, wherein, when identifying the user and associating personal objects with the user, the vehicle display server is adapted to utilize machine learning and artificial intelligence algorithms and probabilistic calculations based on the stored historical data.

13. A method of automatically logging a user out of user specific content displayed on a vehicle display having a vehicle display server positioned within a vehicle and in communication with:
a plurality of sensors positioned within the vehicle and adapted to:
track head and eye position and movement of users seated within a plurality of seating positions within the vehicle;
detect locations of users within the vehicle and when users change seating positions within the vehicle;
detect when a user enters and exits the vehicle;
detect personal objects that are brought into the vehicle by a user;
haptic feedback devices positioned within the vehicle and adapted to provide haptic feedback to users seated within the vehicle; and
a user display system positioned within the vehicle for viewing and interaction by users seated within the plurality of seating positions within the vehicle;
the method including, with the vehicle display server:
detecting when a user enters the vehicle;
identifying, using the plurality of sensors positioned within the vehicle, computer vision algorithms and stored data, an identity of the user;
detecting, using the plurality of sensors positioned within the vehicle, a first one of the plurality of seating positions within which the user sits;
detecting, using the plurality of sensors positioned within the vehicle, personal objects brought into the vehicle by the user;
associating, using artificial intelligence and machine learning algorithms, the detected personal objects, with the user;
displaying user specific content on the user display system for viewing by the user;
detecting when the user is no longer viewing the user specific content on the user display system; and
automatically terminating display of the user specific content and automatically logging-out from the user specific content when the user is no longer viewing the user specific content on the user display system.

14. The method of claim 13, further including, with the vehicle display server:
detecting when the user has looked away from the user display system and is still seated within the first one of the plurality of seating positions within the vehicle;
pausing display of the user specific content for the user on the user display system; and
when a pre-determined amount of time has passed, terminating display of the user specific content and automatically logging-out from the user specific content.

15. The method of claim 14, further including, with the vehicle display server:
detecting when the user has moved away from the one of the plurality of seating positions within the vehicle;
pausing display of the user specific content for the user on the user display system at the first one of the plurality of seating positions; and, at least one of:
when a pre-determined amount of time has passed, automatically terminating display of the user specific content and automatically logging-out from the user specific content that is being displayed on the user display system at the first one of the plurality of seating positions;
detecting, with the plurality of sensors, that the user has moved to a second one of the plurality of seating positions, and automatically terminating display of the user specific content and automatically logging-out from the user specific content that is being displayed by the user display system at the first one of the plurality of seating positions;
detecting, with the plurality of sensors, that another passenger has moved into the first one of the plurality of seating positions, and automatically terminating display of the user specific content and automatically logging-out from the user specific content that is being displayed by the user display system at the first one of the plurality of seating positions; and
detecting, with the plurality of sensors, that the user has exited the vehicle, and automatically terminating display of the user specific content and automatically logging-out from the user specific content that is being displayed by the user display system at the first one of the plurality of seating positions.

16. The method of claim 15, further including, with the vehicle display server:
detecting, with the plurality of sensors, when the user has moved away from the first one of the plurality of seating positions and has left at least one personal object associated with the user at the first one of the plurality of seating positions, and providing an alert for the user to notify the user that at least one personal object associated with the user has been left within the first one of the plurality of seating positions;
detecting, with the plurality of sensors, when the user has moved away from the first one of the plurality of seating positions and has taken at least one personal object associated with a different passenger, and providing an alert for the user to notify the user that the user has taken at least one personal object associated with a different passenger; and
detecting, with the plurality of sensors, when a different passenger within the vehicle has moved from one of the plurality of seating positions within the vehicle and has taken at least one personal object associated with the user, and providing an alert for the user to notify the user that another passenger has taken at least one personal object associated with the user.

17. The method of claim 16, wherein, the providing an alert by the vehicle display server includes at least one of:
providing an audible chime or bell;
providing verbal alerts broadcast generally within the vehicle;
providing directional verbal alerts, broadcast specifically to the user;
providing user specific graphics and textual messages displayed on the user display system;
providing user specific haptic alerts with the plurality of haptic devices within the vehicle; and
disabling doors of the vehicle.

18. The method of claim 17, wherein the system further includes a personal device of the user that is registered with and linked to the system, wherein, the providing an alert by the vehicle display server further includes sending an alert to the user's personal device.

19. A system for automatically logging a user out of user specific content displayed on a vehicle display, comprising:
a vehicle display server positioned within a vehicle and in communication with:
a plurality of sensors positioned within the vehicle and adapted to:
track head and eye position and movement of users seated within a plurality of seating positions within the vehicle;
detect locations of users within the vehicle and when users change seating positions within the vehicle;
detect when a user enters and exits the vehicle;
detect personal objects that are brought into the vehicle by a user;
haptic feedback devices positioned within the vehicle and adapted to provide haptic feedback to users seated within the vehicle; and
a user display system positioned within the vehicle for viewing and interaction by users seated within the plurality of seating positions within the vehicle;
the vehicle display server adapted to:
detect when a user enters the vehicle;
identify, using the plurality of sensors positioned within the vehicle, computer vision algorithms and stored data, an identity of the user;
detect, using the plurality of sensors positioned within the vehicle, a first one of the plurality of seating positions within which the user sits;
detect, using the plurality of sensors positioned within the vehicle, personal objects brought into the vehicle by the user;
associate, using artificial intelligence and machine learning algorithms, the detected personal objects, with the user;
display user specific content on the user display system for viewing by the user; and
at least one of:
detect when the user is no longer viewing the user specific content on the user display system, and automatically terminate display of the user specific content and automatically log-out from the user specific content when the user is no longer viewing the user specific content on the user display system;
detect when the user has looked away from the user display system and is still seated within the first one of the plurality of seating positions within the vehicle, and pause display of the user specific content for the user on the user display system, and when a pre-determined amount of time has passed, terminate display of the user specific content and automatically log-out from the user specific content;
detect when the user has moved away from the one of the plurality of seating positions within the vehicle, and pause display of the user specific content for the user on the user display system at the first one of the plurality of seating positions, and at least one of:
when a pre-determined amount of time has passed, automatically terminate display of the user specific content and automatically log-out from the user specific content that is being displayed on the user display system at the first one of the plurality of seating positions;
detect, with the plurality of sensors, that the user has moved to a second one of the plurality of seating positions, and automatically terminate display of the user specific content and automatically log-out from the user specific content that is being displayed by the user display system at the first one of the plurality of seating positions;
detect, with the plurality of sensors, that another passenger has moved into the first one of the plurality of seating positions, and automatically terminate display of the user specific content and automatically log-out from the user specific content that is being displayed by the user display system at the first one of the plurality of seating positions; and
detect, with the plurality of sensors, that the user has exited the vehicle, and automatically terminate display of the user specific content and automatically log-out from the user specific content that is being displayed by the user display system at the first one of the plurality of seating positions.

20. The system of claim 19, wherein the vehicle display server is further adapted to:
detect, with the plurality of sensors, when the user has moved away from the first one of the plurality of seating positions and has left at least one personal object associated with the user at the first one of the plurality of seating positions, and provide an alert for the user to notify the user that at least one personal object associated with the user has been left within the first one of the plurality of seating positions;
detect, with the plurality of sensors, when the user has moved away from the first one of the plurality of seating positions and has taken at least one personal object associated with a different passenger, and provide an alert for the user to notify the user that the user has taken at least one personal object associated with a different passenger; and
detect, with the plurality of sensors, when a different passenger within the vehicle has moved from one of the plurality of seating positions within the vehicle and has taken at least one personal object associated with the user, and provide an alert for the user to notify the user that another passenger has taken at least one personal object associated with the user;
wherein, the alert provided by the vehicle display server includes at least one of:
an audible chime or bell;
verbal alerts broadcast generally within the vehicle;
directional verbal alerts, broadcast specifically to the user;
user specific graphics and textual messages displayed on the user display system;
user specific haptic alerts provided by the plurality of haptic devices within the vehicle;
disabling doors of the vehicle; and
alerts sent to a user's personal device that is registered and linked to the system; and
further wherein, the user display system comprises one of:
a plurality of individual display screens adapted to display information and receive input from a user, one individual display screen associated with each of the plurality of seating positions within the vehicle; or
a single display system comprising:
at least one display for projecting an image;
a plurality of reflectors, each reflector associated with a one of the plurality of seating positions within the vehicle and adapted to reflect a projected image to the associated one of the plurality of seating positions, such that a user seated at the associated one of the plurality of seating positions within the vehicle perceives the image floating at a central location within the vehicle; and
a transparent cylindrical touch screen display positioned between the plurality of seating positions within the vehicle and the plurality of reflectors and adapted to display user specific content for users at each of the plurality of seating positions within the vehicle and receive input from each of the users at each of the plurality of seating positions within the vehicle.
